(19) United States
(12) Patent Application Publication
(10) Pub. No.: US 2022/0137899 A1
(43) Pub. Date: May 5, 2022

(54) NON-TRANSITORY COMPUTER-READABLE STORAGE MEDIUM STORING PROGRAM, DISPLAY METHOD, AND PRINT CONTROLLER

(71) Applicant: Seiko Epson Corporation, Tokyo (JP)

(72) Inventors: Haruka NISHIMURA, Okaya-shi (JP); Yuji SAITO, Matsumoto-shi (JP); Yusuke YAMADA, Shiojiri-shi (JP)

(21) Appl. No.: 17/516,832

(22) Filed: Nov. 2, 2021

(30) Foreign Application Priority Data
Nov. 4, 2020 (JP) 2020-184306

(51) Int. Cl. G06F 3/12

(52) U.S. Cl. CPC G06F 3/1242; G06F 3/1208; G06F 3/125; G06F 3/1264; G06F 3/1205

(57) ABSTRACT

A print control program causes a processor to display a first page image including a first image out of an image group including images corresponding to the pages in document data, receive a change instruction to change from the display of the first page image to the display of a second page image including a second image included in the image group, and when receiving the change instruction, change from the display of the first page image to the display of the second page image in a change mode in accordance with a received print setting.

The present application is based on, and claims priority from JP Application Serial Number 2020-184306, filed Nov. 4, 2020, the disclosure of which is hereby incorporated by reference herein in its entirety.

### BACKGROUND

### 1. Technical Field

The present disclosure relates to a non-transitory computer-readable storage medium storing a program, a display method, and a print controller.

### 2. Related Art

Techniques for displaying an image of a page included in a document are known (for example, refer to JP-A-2013-200652). JP-A-2013-200652 discloses a technique for displaying by animation the processing process at printing time in accordance with a print setting by using a thumbnail image as an image of a page.

However, JP-A-2013-200652 has a problem in which a user is unable to easily confirm in what state each page of a document is to be printed in accordance with a print setting.

### SUMMARY

According to an aspect of the present disclosure, there is provided a non-transitory computer-readable storage medium storing a program to be executed by a computer, the program causing the computer to perform processing including: receiving a print setting of document data including a plurality of pages; displaying a first page image including a first image out of an image group including images corresponding to the pages of the document data; and receiving a change instruction to change from display of the first page image to display of a second page image including a second image out of the image group, wherein when the change instruction is received, changing from display of the first page image to display of the second page image in a change mode in accordance with the received the print setting.

According to another aspect of the present disclosure, there is provided a display method of a print controller receiving a print setting of document data including a plurality of pages, the display method including: receiving input of a print setting; displaying a first page image including a first image out of an image group including images corresponding to the pages of the document data; and when receiving a change instruction to change from display of the first page image to display of a second page image including a second image out of the image group, changing from display of the first page image to display of the second page image in a change mode in accordance with the received the print setting.

According to still another aspect of the present disclosure, there is provided a print controller including: a reception section configured to receive a print setting of document data including a plurality of pages and a change instruction to change from display of a first page image including a first image out of an image group including the pages of the document data to display of a second page image including a second image out of the image group; a display section; and a display controller configured to control display of the display section, wherein when the reception section receives the change instruction, the display controller changes from display of the first page image to display of the second page image in a change mode in accordance with the print setting received by the reception section.

### BRIEF DESCRIPTION OF THE DRAWINGS

FIG. 1 is a diagram illustrating the configuration of a printing system.

FIG. 2 is a diagram illustrating an example of a preview screen.

FIG. 3 is a diagram illustrating an example of a preview screen.

FIG. 4 is an explanatory diagram of changing display of page images.

FIG. 5 is an explanatory diagram of changing display of page images.

FIG. 6 is an explanatory diagram of changing display of page images.

FIG. 7 is an explanatory diagram of changing display of page images.

FIG. 8 is a flowchart illustrating the operation of a print control section.

### DESCRIPTION OF EXEMPLARY EMBODIMENTS

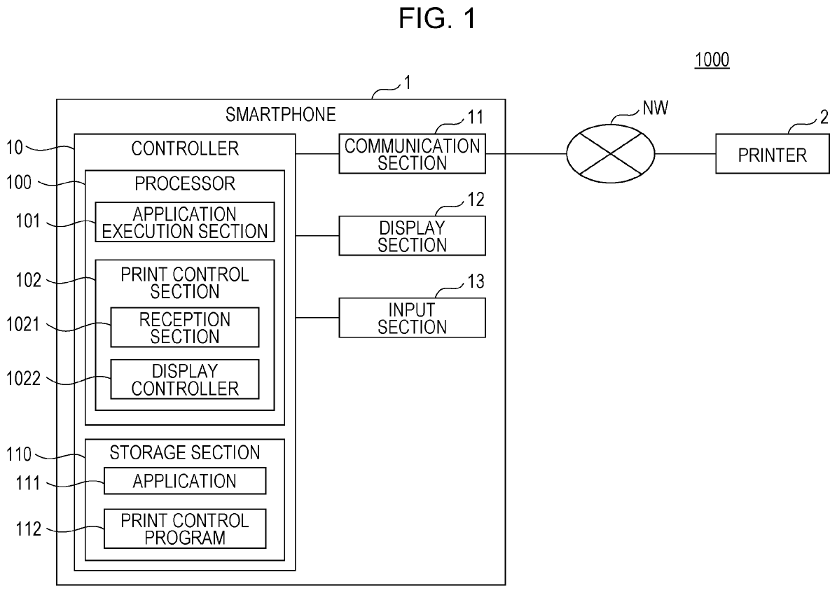

FIG. 1 is a diagram illustrating the configuration of a printing system 1000. The printing system 1000 includes a smartphone 1 and a printer 2. The smartphone 1 and the printer 2 are connected to a network NW. The network NW may be a local network or a global network, which includes the Internet, a dedicated circuit, a public circuit, or the like. The smartphone 1 corresponds to an example of the print controller.

The smartphone 1 may be a notebook PC (personal computer), a desktop PC, or a tablet terminal.

The printer 2 is a device that prints an image on a print medium. The type of the print medium is not limited, and a predetermined size of cut paper, roll paper, synthetic resin sheet, and the like are examples. The printing method of the printer 2 is not limited. It is possible to employ a printing method, such as a dot impact type, a thermal sublimation type, a thermal type, or the like. In the present embodiment, the case where the printing method of the printer 2 is an ink jet method is exemplified.

A description will be given of the smartphone 1. The smartphone 1 includes a controller 10, a communication section 11, a display section 12, and an input section 13.

The controller 10 includes a processor 100 that executes a program, such as a CPU (central processing unit), an MPU (micro-processing unit), or the like, and a storage section 110, and controls each section of the smartphone 1. The processor 100 reads a program stored in the storage section 110 and performs various kinds of processing by hardware and software. The processor 100 executes an application 111 stored in the storage section 110 to function as an application execution section 101. The processor 100 executes a print control program 112 stored in the storage section 110 to function as a print control section 102. The processor 100 corresponds to an example of the computer. The print control program 112 corresponds to an example of the program.

The storage section 110 stores programs to be executed by the processor 100 and data to be processed by the processor 100. The storage section 110 stores the application 111, the print control program 112, and various programs to be executed by the processor 100, and the other various kinds of data. The storage section 110 has a nonvolatile storage area and a volatile storage area. The volatile storage area may include a work area of the processor 100.

The application 111 is an application program that generates document data. The document data is data representing a document including one or a plurality of pages. For the data format of the document data generated by the application 111, a PDF (Portable Document Format), a Word format, or the like is given as an example. The application 111 outputs an instruction to print document data.

The print control program 112 has a function of outputting print data based on document data to the printer 2 connected to the smartphone 1, and instructs printing to the printer 2. The print control program 112 has a function of performing the print setting of document data. The print control program 112 has a function of displaying a thumbnail image SG of a page included in a document represented by document data per page unit on the display section 12 of the smartphone 1. The print control program 112 has a function of generating a paper image YG, which is an image corresponding to paper, based on document data per paper unit included in a printed material, and displaying the paper image YG. The print control program 112 may have a function of generating a thumbnail image SG. The print control program 112 may obtain the document data and the thumbnail image SG generated based on the document data from a server or a client device, not illustrated in FIG. 1, via the network NW and cause to display the obtained thumbnail image SG.

The communication section 11 is a communication interface that performs communication conforming to a predetermined communication standard, and communicates with the printer 2 under the control of the controller 10 via the network NW. The communication section 11 transmits the print data output by the print control program 112 to the printer 2. The print data includes a print setting. The communication section 11 receives document data and a thumbnail image SG generated based on the document data from a server or a client device, which is not illustrated in FIG. 1, via the network NW.

The display section 12 is a display including an LED (light emitting diode), an OLED (organic light emitting diode), or the like, and displays information in a predetermined mode under the control of the controller 10. The display section 12 may be an external device coupled to the smartphone 1.

The input section 13 is an input interface that is coupled to an input mechanism, such as an operation switch disposed on the smartphone 1, a touch input type panel configured integrally with a display, a mouse, a keyboard, or the like, which is an external device, and detects user input operation, and outputs a detection result to the controller 10. The controller 10 performs processing corresponding to the input operation based on the input from the input section 13.

The application execution section 101 generates document data and outputs the generated document data to the print control section 102.

The print control section 102 sets a printing condition of document data and causes the communication section 11 to transmit print data including the print setting based on the set printing condition to the printer 2. The print control section 102 may generate print data corresponding to a predetermined command system based on the document data. As illustrated in FIG. 1, the print control section 102 functions as a reception section 1021 and a display controller 1022.

The reception section 1021 receives various kinds of input from a user, which has responded to a preview screen 1023 displayed by the display controller 1022 on the display section 12. The preview screen 1023 is a screen on which an image of a printed material to be generated by the printer 2 is displayed.

The display controller 1022 displays the preview screen 1023 on the display section 12. The display controller 1022 generates the paper image YG in accordance with the print setting received by the reception section 1021. The display controller 1022 displays the thumbnail image SG and the paper image YG on the preview screen 1023. When the reception section 1021 receives input of a change instruction from a user, the display controller 1022 changes display of the preview screen 1023 displayed on the display section 12.

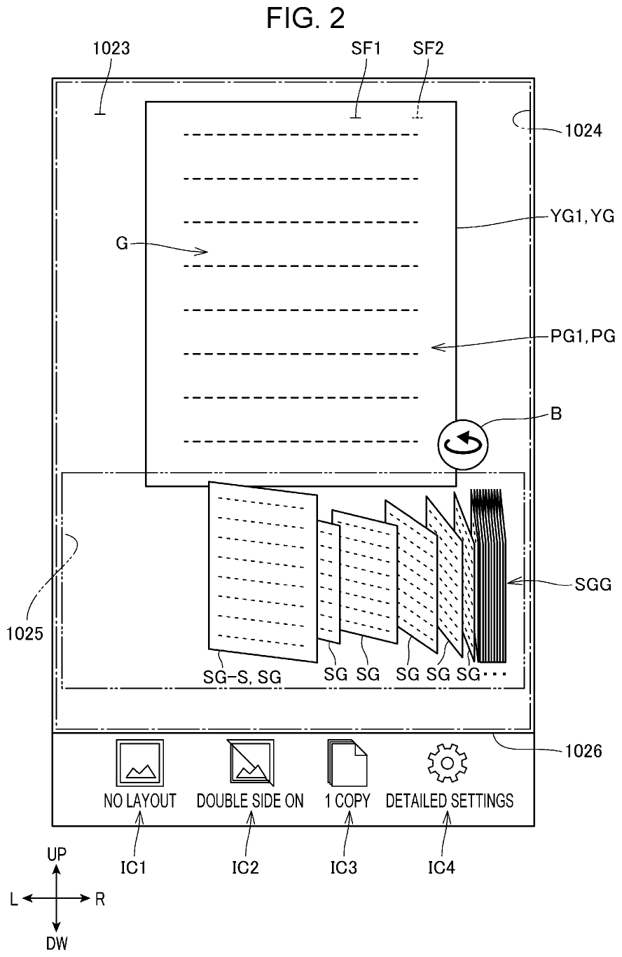

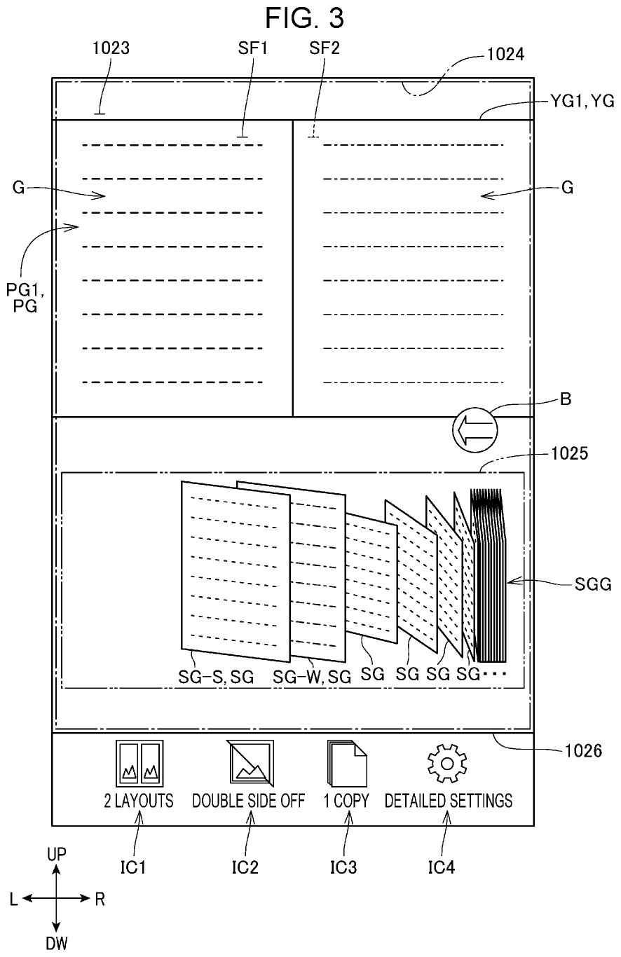

FIG. 2 and FIG. 3 are diagrams illustrating an example of the preview screen 1023. The preview screen 1023 in FIG. 2 illustrates an example of the preview screen 1023 when the print setting is set to perform double-sided printing with long side binding without layout printing. The preview screen 1023 in FIG. 3 illustrates an example of the preview screen 1023 when the print setting is set to perform single-sided printing with layout printing.

In FIG. 2 and FIG. 3, an up direction is denoted by a sign UP representing upward, a down direction is denoted by a sign DW representing downward, a left direction is denoted by a sign L representing leftward, and a right direction is denoted by a sign R representing rightward.

The preview screen 1023 includes a paper image display area 1024, a thumbnail image group display area 1025, and an icon display area 1026. The paper image display area 1024 corresponds to the first display area and an example of the display area. The thumbnail image group display area 1025 corresponds to an example of the second display area.

The paper image display area 1024 and the icon display area 1026 are arranged vertically on the preview screen 1023. The thumbnail image group display area 1025 is an area extending horizontally, and is disposed under the area of the paper image display area 1024 by being superposed on the paper image display area 1024. In FIG. 2 and FIG. 3, the thumbnail image group display area 1025 is superposed on the paper image display area 1024. However, the paper image display area 1024 and the thumbnail image group display area 1025 may be disposed as divided areas.

A description will be given of the thumbnail image group display area 1025. The thumbnail image group display area 1025 is an area in which a thumbnail image group SGG is displayed. The thumbnail image group SGG includes one or a plurality of thumbnail images SG. When a plurality of thumbnail images SG are included in the thumbnail image group SGG, the plurality of thumbnail images SG are horizontally arranged in the thumbnail image group display area 1025. The right direction and the left direction correspond to examples of the predetermined direction. The thumbnail images SG included in the thumbnail image group SGG are displayed in an arranged state as a bird's-eye view from a predetermined viewpoint different from a front viewpoint. FIG. 2 and FIG. 3 are views of the thumbnail image group SGG when seen from above. One thumbnail image SG included in the thumbnail image group SGG is a reduction image of an image G corresponding to one page of a document represented by document data. The image displayed as one thumbnail image SG included in the thumbnail image group SGG is a reduction image of the image G of one page included in the document represented by the generated document data.

In the thumbnail image group display area 1025, when the input section 13 detects a predetermined input operation, the display mode of the thumbnail image group SGG is changed. The following operations are given as the predetermined input operation. A touch operation in which an indicator, such as a finger, a touch pen, or the like is moved in contact with the panel, and a slide operation in which an indicator is slidingly moved in contact with the panel are examples. When the input section 13 is coupled to a mouse, a slide operation in which a mouse is moved in a state in which a pointer is put on the thumbnail image group display area 1025, or the like. When slidingly move in the right direction is performed as the slide operation, the thumbnail images SG are moved one by one from the left to the right in accordance with the rightward slide amount. When a slidingly move operation in the left direction is performed, the thumbnail images SG are moved one by one from the right to the left in accordance with the leftward slide amount.

When one thumbnail image SG is selected by an indicator, or the like out of the thumbnail image group SGG displayed in the thumbnail image group display area 1025, a selection thumbnail image SG-S is displayed in a size larger than the thumbnail images SG other than the selection thumbnail image SG-S. FIG. 2 illustrates the thumbnail image SG of the image of the top page as the selection thumbnail image SG-S out of the pages included in the document as an example.

When the print setting is set to a setting to perform layout printing, as illustrated in FIG. 3, the selection thumbnail image SG-S and a thumbnail image SG-W of the image to be allocated are displayed in a size lager than the size of the other thumbnail images SG in the thumbnail image group display area 1025. In the setting to perform layout printing in which the number of layouts is two, when a selection thumbnail image SG-S is a thumbnail image SG indicating the image of the top page, as illustrated in FIG. 3, a thumbnail image SG-W corresponding to the next page of the top page and the selection thumbnail image SG-S are displayed in a size larger than the size of the other thumbnail images SG.

A description will be given of the icon display area 1026. The icon display area 1026 is an area in which icons related to the print setting are displayed. In the icon display area 1026, a layout print setting icon IC1, a double-sided print setting icon IC2, the number of copies setting icon IC3, and a detailed setting icon IC4 are horizontally arranged and displayed.

The layout print setting icon IC1 is an icon for setting presence or absence of layout printing. The user operates the layout print setting icon IC1 to input the setting of presence or absence of layout printing as a print setting. The reception section 1021 receives the input using the layout print setting icon IC1 as a print setting. The layout print setting icon IC1 in FIG. 2 indicates the setting of not performing layout printing. The layout print setting icon IC1 in FIG. 3 indicates the setting of performing layout printing with the number of layouts of two.

The double-sided print setting icon IC2 is an icon for setting presence or absence of double-sided printing. The user operates the double-sided print setting icon IC2 to input the setting of presence or absence of double-sided printing as a print setting. The reception section 1021 receives the input performed by using the double-sided print setting icon IC2 as a print setting. The double-sided print setting icon IC2 in FIG. 2 indicates the setting for performing double-sided printing. The double-sided print setting icon IC2 in FIG. 3 indicates the setting for not performing double-sided printing.

The number of copies setting icon IC3 is an icon for setting presence or absence of plural number of copies for printing. The user operates the number of copies setting icon IC3 to input the setting of presence or absence of plural number of copies for printing. The reception section 1021 receives the input performed by using the number of copies setting icon IC3 as a print setting. The number of copies setting icon IC3 in FIG. 2 and FIG. 3 indicates that one copy of the document is to be printed based on the document data.

The detailed setting icon IC4 is an icon related to the detailed settings for printing. In the case of performing layout printing, the user operates the detailed setting icon IC4 to input any number of layouts. In the case of performing double-sided printing, the user operates the double-sided print setting icon IC2 to input the setting to specify the print mode of the double-sided printing to either with long-side binding printing or with short-side binding printing. In the case of performing plural number of copies printing, the user inputs the setting of any number of copies. The user operates the detailed setting icon IC4 to input the setting related to the staple processing. The reception section 1021 receives input performed by using the number of copies setting icon IC3 as a print setting. The setting related to the staple processing is a setting of a staple position. When a post-processing device that performs staple processing is attached to the printer 2, the setting indicates the staple position performed by the post-processing device. When the printer 2 does not includes a post-processing device, the staple position assumed to be performed by the user at the time of staple processing is set in the setting of the staple processing.

The print settings that the user is able to input by using the detailed setting icon IC4 are not limited to the settings described above, and may include the other settings, such as the setting of whether or not to perform borderless printing, the setting of paper size, and the like.

The paper image display area 1024 is an area in which the paper image YG is displayed. The paper image YG is an image representing one sheet of paper included in a printed material to be generated by the printer 2 based on the document data. In the following description, when denoting a paper image YG by distinguishing in units of sheets, a number is added after a sign YG. That is to say, the n-th paper image YG is denoted by the n-th paper image YGn. Here, n is an integer of one or more and indicates the n-th.

The paper image YG includes an image G in the document data in a first face SF1. The image G is one page image in the document data. In the following description, when the image G is denoted by distinguishing a page in the document data, a page number is added after the sign G. The image G of the m-th page in the document data is denoted by the m-th image Gm. Here, m is an integer of one or more. The images of the first face SF1 and the second face SF2 in the paper image YG are the page images PG including the images G in the document data. The shape of the page image PG is a rectangle having a long side and a short side. When the image of the first face SF1 is formed by one image G, the image G matches the page image PG. When a layout printing with the number of layouts of two is set, the image of the first face SF1 of the paper image YG becomes a page image PG including two images G. When the paper image YG is distinguished in face units, the page image PG is denoted by adding a number after the sign PG. The i-th page image PG is denoted by the i-th page image PGi. Here, i is an integer of one or more and indicates the i-th.

The display controller 1022 causes to display a paper image YG in accordance with the print setting received by the reception section 1021 from the icon display area 1026 in the paper image display area 1024.

When the reception section 1021 receives a setting to perform double-sided printing, the n-th paper image YGn displayed in the paper image display area 1024 includes the first face SF1, which is the i-th page image PG including the m-th image Gm, and the second face SF2, which is the back side of the first face SF1 and is the (i+1)-th page image PGi+1 including the (m+1)-th image Gm+1. When the print setting is a setting to perform double-sided printing, the i-th page image PGi, which is the image of the first face SF1 of the n-th paper image YGn, corresponds to an example of the first page image. The (i+1)-th page image PGi+1, which is the image of the second face SF2 of the n− the paper image YGn, corresponds to an example of the second page image.

When the reception section 1021 receives a setting to perform single-sided printing and displays the second face SF2 of the paper image YG in the paper image display area 1024, the n-th paper image YGn displayed in the paper image display area 1024 is the second face SF2, which is a blank page image PGw indicating blank paper not including an image G. The setting to perform single-sided printing corresponds to an example of the second setting. When the print setting is a setting to perform single-sided printing, and the second face SF2 of the paper image YG is not displayed in the paper image display area 1024, the i-th page image PGi of the first face SF1 of the n-th paper image YGn corresponds to an example of the first page image. The page image PGi+1 of the first face SF1 of the (n+1)-th paper image YGn+1 corresponds to an example of the second page image.

When the reception section 1021 receives a setting to perform layout printing, the n-th paper image YGn displayed in the paper image display area 1024 includes the first face, which is a page image PG including the images G corresponding to the number of layouts. As illustrated in FIG. 3, when the number of layouts is two, the image of the first face SF1 is the page image PG including the image G corresponding to the selection thumbnail image SG-S and the image G corresponding to the thumbnail image SG-W of the page next to the selection thumbnail image SG-S.

In the paper image display area 1024, a paper image YG is displayed above the thumbnail image group SGG at the position where the center of the horizontal side of the paper image YG matches or substantially matches the center of the horizontal side to the paper image display area 1024. In the paper image display area 1024, a display change button that changes the display of the paper image YG or the page image PG is displayed. The display change button B is a software button. The position at which the display change button B is disposed is not limited as long as in the paper image display area 1024 except the thumbnail image group display area 1025. The reception section 1021 receives input of a display change instruction from a user via the display change button B. When the reception section 1021 receives a change instruction, the display controller 1022 changes the page image PG to display or the paper image YG. The change mode differs depending on the print setting received by the reception section 1021 via the icon display area 1026.

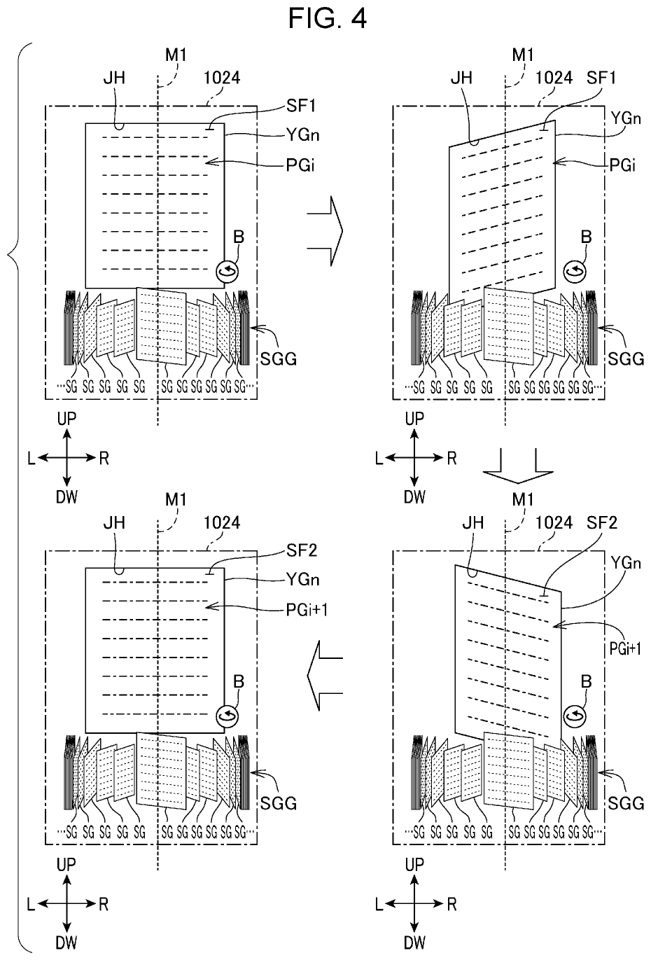

Referring to FIG. 4 to FIG. 7, descriptions will be given of the case where the print setting is a setting to perform double-sided printing with long side binding, a setting to perform double-sided printing with short side binding, a setting to perform single-sided printing, and a setting related to staple processing.

In FIG. 4 to FIG. 7, an up direction in the diagrams is denoted by a sign UP, a down direction in the diagrams is denoted by a sign DW, a left direction in the diagrams is denoted by a sign L, and a right direction in the diagrams is denoted by a sign R. FIG. 4 to FIG. 7 illustrate the case where the long side of the page image PG is vertically disposed in the paper image display area 1024, and the short side of the page image PG is horizontally disposed in the paper image display area 1024. The preview screen 1023 illustrates an example in which the sides disposed vertically are longer than the sides disposed horizontally.

FIG. 4 is an explanatory diagram of changing display of page images when the print setting is to perform double-sided printing with long side binding.

As illustrated in FIG. 4, when the display change button B is operated, the display controller 1022 rotates the n-th paper image YGn around a first virtual axis M1. The first virtual axis M1 is an axis that is positioned at the center of, or a substantially center of the side extending horizontally in the paper-image display area 1024, and is parallel to the long side of the page image PG, which is the first face SF1 of the paper image YG. By rotating the paper image YG, the page image PG, which is the first face SF of the paper image YG, is rotated. The first virtual axis M1 corresponds to an example of the predetermined axis.

In the mode of seeing as a bird's-eye-view from a predetermined viewpoint, the display controller 1022 rotates the paper image YG counterclockwise around the first virtual axis M1. The display controller 1022 rotates the paper image YG 180° from the state of displaying the first face SF1 of the paper image YG to the state of displaying the second face SF2. As illustrated in FIG. 4, in the paper image display area 1024, the i-th page image PGi, which is the first face SF1 of the n-th paper image YGn, is changed to the (i+1)-th page image PGi+1, which is the second face SF2 of the n-th paper image YGn.

In FIG. 4, it is assumed that the first virtual axis M1 is positioned at the center of, or a substantially center of the side extending horizontally in the paper-image display area 1024, and is parallel to the long side of the page image PG, which is the first face SF1 of the paper image YG. However, the horizontal position of the first virtual axis M1 is not limited as far as the first virtual axis M1 is parallel to the long side of the page image PG.

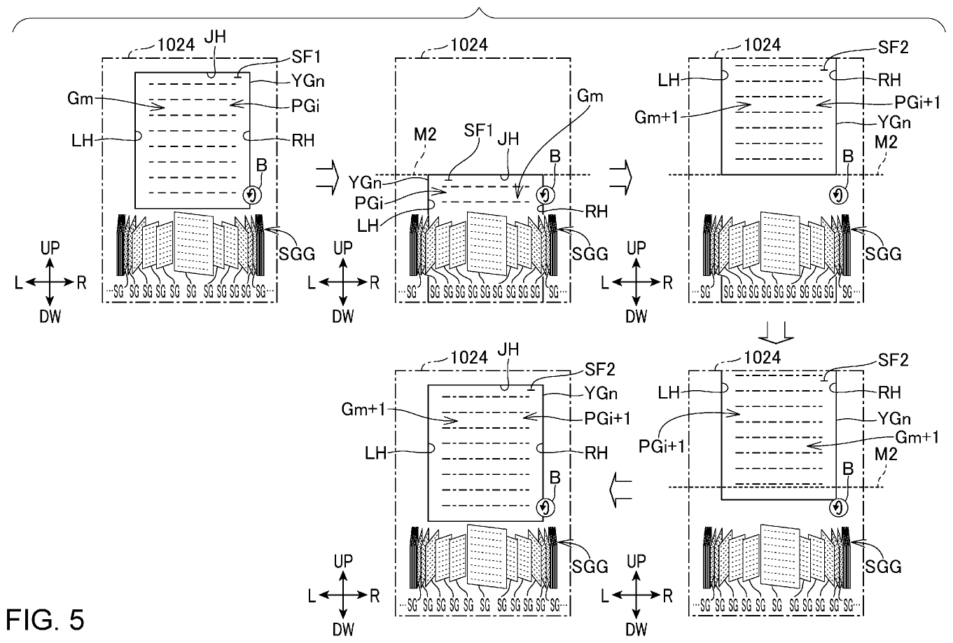

FIG. 5 is an explanatory diagram of changing display of page images when the print setting is a setting to perform double-sided printing with short side binding. FIG. 5 illustrates the changes in the paper image display area 1024 when display is changed from the i-th page image PGi, which is first face SF1 of the n-th paper image YGn positioned at the n-th to the (i+1)-th page image PGi+1, which is the second face SF2. The i-th page image PGi includes the m-th image Gm, which is the m-th page of the document data, and the (i+1)-th page image PGi+1 includes the (m+1)-th page image Gm+1, which is the (m+1)-th page of the document data.

When the display change button B is operated, the display controller 1022 slidingly moves the upper side JH of the paper image YG in the direction to a second virtual axis M2 positioned below the upper side JH. The second virtual axis M2 is an axis parallel to the short side of the page image PG, which is the first face SF1 of the paper image YG. The second virtual axis M2 corresponds to an example of the predetermined axis.

After slidingly moving the paper image YG downward, the display controller 1022 rotates the paper image YG around the second virtual axis M2. As an example, the display controller 1022 slidingly moves the paper image YG to the position where the upper side JH of the paper image YG is put on the second virtual axis M2, and then by using the upper side JH of the paper image YG as the second virtual axis M2, the display controller 1022 rotates the paper image YG around the second virtual axis M2. The display controller 1022 rotates the paper image YG 180° from the state of displaying the first face SF1 to the state of displaying the second face SF2. By slidingly moving the paper image YG downward and then rotating the paper image YG, it is possible to enlarge the display area of the second face SF2 of the paper image YG to be displayed after the rotation. In particular, this is effective when the vertical side of the paper image display area 1024 is shorter than twice the long side of the paper image YG.

After rotating the paper image YG 180°, the display controller 1022 slidingly moves the paper image YG downward to the position where the first face SF1 of the paper image YG was displayed before slidingly moving the paper image YG.

In FIG. 5, in the paper image display area 1024, display of the i-th page image PGi, which is the first face SF1 of the n-th paper image YGn, is changed to display of the (i+1)-th page image PGi+1, which is the second face SF2.

In FIG. 5, the upper side JH of the paper image YG is put on the second virtual axis M2 and then the paper image YG is rotated. However, the upper side JH may not be put on the second virtual axis M2 and be rotated. The vertical position of the second virtual axis M2 is not limited as far as the second virtual axis M2 is parallel to the short side of the page image PG.

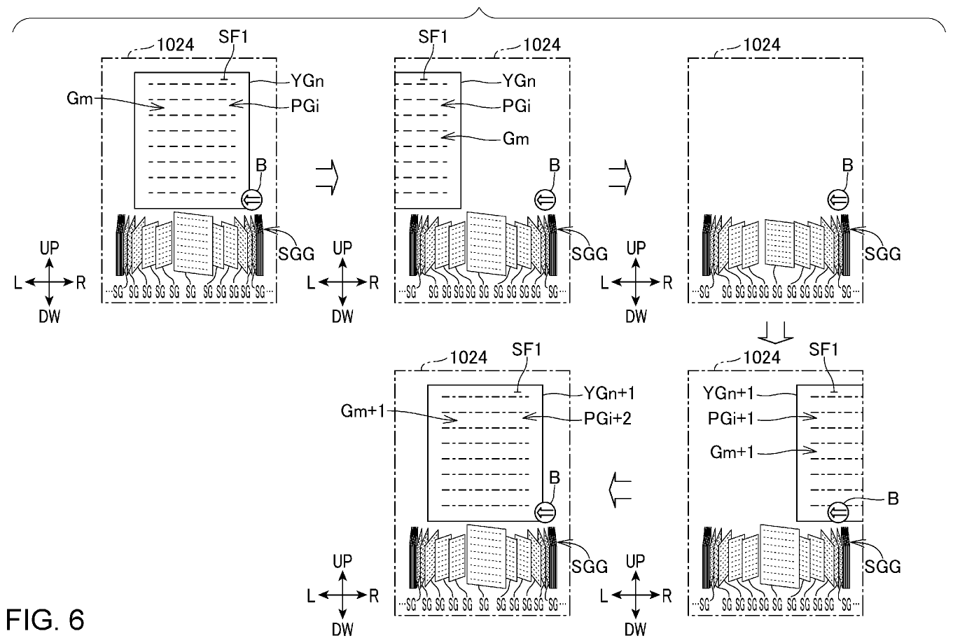

FIG. 6 is an explanatory diagram of changing display of page images when the print setting is a setting to perform single-sided printing. FIG. 6 illustrates the changes from the state in which the n-th paper image YGn, which is the n-th, is displayed to the state in which the (n+1)-th paper image YGn+1, which is the (n+1)-th, is displayed. The i-th page image PGi, which is the first face SF1 of the n-th paper image YGn, includes the m-th image Gm, which is the m-th page in the document data. The (i+1)-th page image PGi+1, which is the first face SF1 of the (n+1)-th paper image YGn+1, includes the (m+1)-th image PGm+1, which is the (m+1)-th page in the document data. In a setting to perform single-sided printing without performing layout printing, the total number of sheets of the paper image YG matches the total number of images G.

When the display change button B is operated, the display controller 1022 slidingly moves the n-th paper image YGn leftward and deletes the n-th paper image YGn from the paper image display area 1024.

During slidingly moving the n-th paper image YGn or after deleting the n-th paper image YGn, the display controller 1022 slidingly moves from the right the (n+1)-th paper image YGn+1, which is the (n+1)-th and following the n-th paper image YGn, and displays the image.

The direction in which the n-th paper image YGn is slidingly moved when deleting the n-th paper image YGn is not limited to leftward and may be rightward, upward, or downward. The direction in which the (n+1)-th paper image YGn+1 is slidingly moved when the (n+1)-th paper image YGn+1 is displayed is not limited to rightward and may be leftward, upward, or downward.

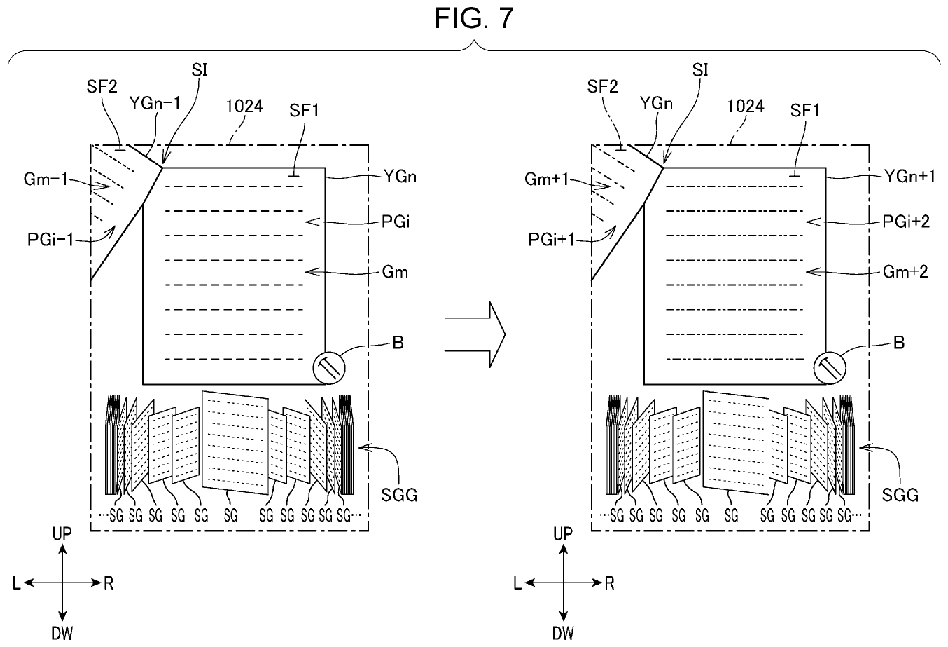

FIG. 7 is an explanatory diagram of changing display of page images when the print setting is a setting to perform staple processing.

FIG. 7 is an explanatory diagram of changing display of page images when the print setting is a setting related to staple processing and performing double-sided printing. The left figure in FIG. 7 illustrates a first state of displaying the i-th page image PGi, which is the first face SF1 of the n-th paper image YGn, and a part of the (i−1)-th page image PGi−1, which is the second face SF2 of the (n−1)-th paper image YGn−1, that is to say, one sheet before the n-th paper image YGn. The right figure in FIG. 7 illustrates a second state, which is changed from the first state, and is a state of displaying the (i+2)-th page image PGi+2, which is the first face SF1 of the (n+1)-th paper image YGn+1 and a part of the (i+1)-th page image PGi+1, which is the second face SF2 of the n-th paper image YGn. The second face SF2 of the (n−1)-th paper image YGn−1 includes the (m−1)-th image Gm−1, which is the (m−1)-th page in the document data. The first face SF1 of the n-th paper image YGn includes the m-th image Gm, which is the m-th page of the document data, and the second face SF2 includes the (m+1)-th image Gm+1, which is the (m+1)-th page. The first face SF1 of the (n+1)-th paper image YGn+1 includes the (m+2)-th image Gm+2, which is the (m+2)-th page of the document data.

When the display change button B is operated, the display controller 1022 moves the n-th paper image YGn in a turning-over mode by using a staple processing position SI as a reference. The staple processing position SI is a position set as a staple processing position, and is illustrated as a position in the upper left corner of the paper image YG in FIG. 7. When moved by using the staple processing position SI as a reference, the n-th paper image YGn is superposed on the second face SF2 of the (n−1)-th paper image YGn−1 in the state of indicating the second face SF2 of the n-th paper image YGn.

When the n-th paper image YGn is moved in the turning-over mode by using the staple processing position SI as a reference, the (n+1)-th paper image YGn+1 is displayed in the paper image display area 1024.

FIG. 7 illustrates an example of the case where the print setting includes a setting to perform double-sided printing. The case where a print setting includes a setting to perform single-sided printing is describe as follows.

The image of the second face SF2 of the (n−1)-th paper image YGn−1 is a blank page image PGw, which is blank paper. The first face SF1 of the n-th paper image YGn includes the m-th image Gm, which is the m-th page of the document data, and the second face SF2 does not include an image G. The first face SF1 of the (n+1)-th paper image YGn+1, which is the (n+1)-th, includes the (m+1)-th image Gm+1, which is the (m+1)-th page of the document data. When the display change button B is operated, the display controller 1022 moves the n-th paper image YGn in the turning-over mode by using the staple processing position SI as a reference. When the n-th paper image YGn is moved by using the staple processing position SI as the reference, in the state of indicating the second face SF2, which is blank paper, the n-th paper image YGn is superposed on the blank page image PGw, which is the second face SF2 of the (n−1)-th paper image YGn−1. When the n-th paper image YGn is moved in the turning-over mode with the staple processing position SI as a reference, the (n+1)-th paper image YGn+1 is displayed in the paper image display area 1024.

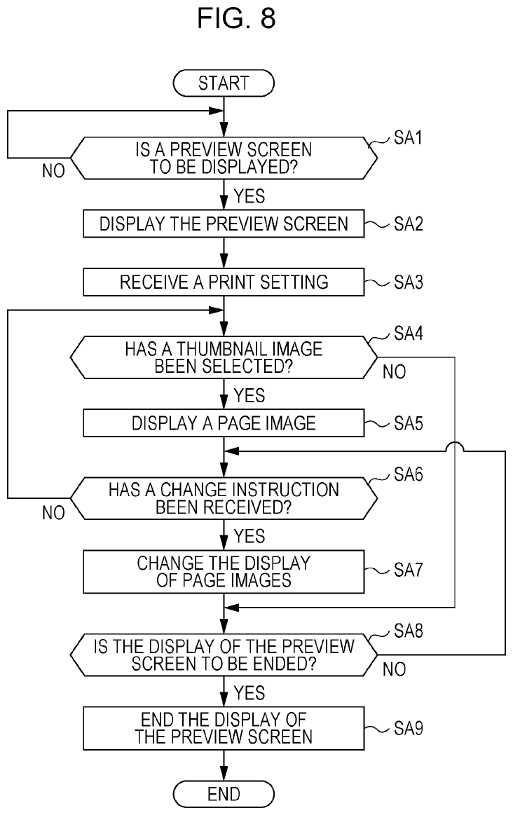

FIG. 8 is a flowchart illustrating the operation of the print control section 102.

When printing of document data is instructed by the application 111, the display controller 1022 determines whether or not to cause the display section 12 to display the preview screen 1023 (step SA1). Alternatively, when document data and a thumbnail image SG that are transmitted from a server or a client device are received by the communication section 11, the display controller 1022 determines whether or not to cause the display section 12 to display the preview screen 1023 (step SA1).

When the display controller 1022 determines to cause the display section 12 to display the preview screen 1023 (step SA1: YES), the display controller 1022 causes the display section 12 to display the preview screen 1023 (step SA2). The display section 12 displays a thumbnail image group SGG corresponding to the document data in the thumbnail image group display area 1025 of the preview screen 1023.

After the display controller 1022 causes the display section 12 to display the preview screen 1023, the reception section 1021 receives input of a print setting from a user via the icon display area 1026 (step SA3).

After the reception section 1021 receives input of a print setting from the user, the display controller 1022 determines whether or not one thumbnail image SG has been selected from the thumbnail image group SGG displayed in the thumbnail image group display area 1025 of the preview screen 1023 (step SA4).

When the display controller 1022 determines that one thumbnail image SG has not been selected (step SA4: NO), the processing of step SA8 is performed.

When the display controller 1022 determines that one thumbnail image SG has been selected (step SA4: YES), the display controller 1022 displays a page image PG including an image G corresponding to a selection thumbnail image SG-S in the paper image display area 1024 as a first face SF1 of the paper image YG (step SA5). The first face SF1 of the paper image YG is a page image PG including the image G corresponding to the selection thumbnail image SG-S.

After the display controller 1022 causes to display the first face SF1 of the paper image YG, the display controller 1022 determines whether or not the reception section 1021 has received a display change instruction (step SA6).

When the display controller 1022 determines that the reception section 1021 has not received a change instruction for a predetermined period (step SA6: NO), the processing of step SA4 is performed again.

When the display controller 1022 determines that the reception section 1021 has received a change instruction (step SA6: YES), the display controller 1022 changes the display in the change mode corresponding to the print setting received by the reception section 1021 (step SA7). The display changes include a change from the n-th paper image YGn to the (n+1) paper image YGn+1 and a change from the i-th page image PGi, which is the first face SF1 of the paper image YG, to the (i+1)-th page image PGi+1, which is the second face SF2, as examples.

The display controller 1022 determines whether or not to end the display of the preview screen 1023 (step SA8). Whether or not to end the display of the preview screen 1023 is determined by whether or not the following instructions are received. The end instructions include an instruction from a user to end the print control program 112, a print instruction of document data via a print instruction icon not illustrated, and input of a command indicating print end from the printer 2 based on a print instruction.

When the display controller 1022 determines not to end the display of the preview screen 1023 (step SA8: NO), the processing is returned to step SA6.

When the display controller 1022 determines to end the display of preview screen 1023 (step SA8: YES), the display controller 1022 ends the display of the preview screen 1023 performed by the display section 12 (step SA9).

The following advantages are obtained by the embodiment described above. The first image, the second image, and the third image used for the description of the following advantages do not indicate specific images. The first image indicates any image, the second image indicates an image different from the first image, and the third image indicates an image different from the first image and the second image.

The first page image PG and the second page image PG used for the description of the following advantages do not indicate specific page image PG. The first page image PG indicates a page image PG including the first image out of any pages included in a printed material, and the second page image PG indicates a page image PG including a second image, which is a page image PG different from the first page image PG. When the print setting is a setting to perform double-sided printing, the first page image PG indicates the i-th page image PGi, which is the first face SF1 of the n-th paper image YGn, and the second page image PG indicates the (i+1)-th page image PGi+1, which is the second face SF2 of the n-th paper image YGn. When the print setting is a setting to perform single-sided printing, the first page image PG indicates the i-th page image PGi, which is the first face SF1 of the n-th paper image YGn, and the second page image PG indicates the (i+1)-th page image PGi+1, which is the first face SF1 of the (n+1)-th paper image YGn+1.

The print control program 112 causes the processor 100 to receive a print setting of the document data including a plurality of pages, to display the first page image PGi including the first image Gm out of the image group including the pages corresponding to the pages of the document data, and to receive a change instruction from the display of the first page image PGi to the display of the second page image PGi+1 including the second image Gm+1 included in the image group. When a change instruction is received, the print control program 112 causes the processor 100 to change from the display of the first page image PGi to the display of the second page image PGi+1 in a change mode in accordance with the received print setting.

In the display method, the smartphone 1 receives input of a print setting, displays the first page image PGi including the first image Gm out of the image group including the images corresponding to the pages of the document data including a plurality of pages, and receives a change instruction from the display of the first page image PGi to the display of the second page image PGi+1 including the second image Gm+1 included in the image group. When a change instruction is received, the display is changed from the display of the first page image PGi to the display of the second page image PGi+1 in the change mode in accordance with the received print setting.

The smartphone 1 includes the reception section 1021 configured to receive a print setting of the document data including a plurality of pages, and input of a change instruction from the display of the first page image PGi including the first image Gm out of the image group including images corresponding to the pages of the document data to the display of the second page image PGi+1 including the second image Gm+1 included in the image group, the display section 12, and the display controller 1022 configured to control the display of the display section 12. When the reception section 1021 receives a change instruction, the display controller 1022 changes from the display of the first page image PGi to the display of the second page image PGi+1 in the change mode in accordance with the print setting received by the reception section 1021.

With the print control program 112, the display method, and the smartphone 1, it is possible to provide the user with a change of display of the page images PG in accordance with the print setting, and thus it becomes possible for the user to easily confirm what is the state of the printed material in accordance with the print setting.

It becomes possible for the user to easily confirm what state of the printed material in accordance with the print setting, and thus it becomes possible for user to intuitively confirm whether or not a desired print setting is performed before starting printing. It is possible for the user to suppress generating a printed material in a print setting undesired by the user, which is caused by a mistake of the print setting.

The print setting is a setting to perform double-sided printing. The change mode is a mode to rotate the first page image PGi around a predetermined axis to change to display of the second page image PGi+1.

Since it is possible to change displays of the page image PG so as to turn the paper over, it becomes possible for the user to intuitively and easily confirm in what state the printed material set for double-sided printing is.

When the print setting is the second setting different from the setting to perform double-sided printing, the change mode is a mode different from the setting to perform double-sided printing.

When the print setting is a setting different from the setting to perform double-sided printing, the change mode is a mode different from the setting to perform double-sided printing, and thus it becomes possible for the user to intuitively and easily confirm in what state of the printed material is in the case of the setting different from double-sided printing.

The second setting is a setting to perform single-sided printing. The change mode is a mode of slidingly moving the first page image PGi in a predetermined direction to delete the first page image PGi, and slidingly moving the second page image PGi+1 to display the second page image PGi+1.

It is possible to change display of the page images PG by slidingly moving the display so as to browse the paper one by one. Accordingly, it becomes possible for the user to intuitively and easily confirm in what state the printed material for single-sided printing is.

The print setting is a setting to perform double-sided printing with long side binding. The change mode is a mode in which the first page image PGi is rotated around the first virtual axis M1 parallel to the long side of the first page image PGi to change to display of the second page image PGi+1.

It is possible to change the display of the page image PG in the mode of turning over the paper printed by double-sided printing with the paper long side binding by using the long side as a reference. It becomes possible for the user to intuitively and easily confirm in what state the printed material set for double-sided printing with long side binding is.

The print setting is a setting to perform double-sided printing with short side binding. The change mode is a mode in which the first page image PGi is rotated around the second virtual axis M2 parallel to the short side of the first page image PGi to change to the display of the second page image PGi+1.

It is possible to change the display of the page images PG in the mode of turning over the paper printed by the double-sided printing with short side binding by using the short side as a reference. It becomes possible for the user to intuitively and easily confirm in what state the printed material set for double-sided printing with short side binding is.

The change mode is a mode in which the first page image PGi is rotated after slidingly moving the first page image PG in a direction perpendicular to the short side.

It becomes possible for the user to intuitively and easily confirm in what state the printed material generated with the setting for double-sided printing with short side binding is.

The print setting is a setting related to the position of the staple processing. The change mode is a mode of moving the first page image PG by using a predetermined position as a reference.

It becomes possible for the user to intuitively and easily confirm the state of the printed material generated with the setting to perform staple processing.

When the print setting includes a setting to perform layout printing, the print control program 112 causes the processor 100 to display the first page image PGi by including a third image corresponding to the layout printing in the first page image PGi.

It is possible to provide the user with the page image PG of when layout printing is set, and thus it becomes possible for the user to intuitively and easily confirm the state of the printed material generated with the setting to perform layout printing.

The print control program 112 causes the processor 100 to display the first page image PGi in the paper image display area 1024 and display, in the thumbnail image group display area 1025, the thumbnail images SG included in the thumbnail image group SGG corresponding to the image group by horizontally arranging the thumbnail images SG.

It becomes possible for the user to easily confirm how each page of the document is printed as a printed material.

When one thumbnail image SG is selected from the thumbnail images SG included in the thumbnail image group SGG displayed in the thumbnail image group display area 1025, the print control program 112 causes the processor 100 to display the first page image PGi in the paper image display area 1024 by using the image indicated by the one selection thumbnail image SG-S as the first image.

It becomes possible for the user to easily confirm how the selected page of the document is printed as a printed material.

Each of the embodiments described above indicates one aspect, and thus it is possible to modify and apply the embodiments in any form.

The printer 2 may have functions other than a print function, such as a scan function, a facsimile function, and the like.

The functions of the controller 10 may be realized by using a plurality of processors or a semiconductor chip.

Each section illustrated in FIG. 1 is an example and is not limited in particular. It is not necessary that hardware corresponding to each section is implemented, and it is of course possible to employ the configuration in which the function of each section is realized by one processor executing a program. A part of the functions realized by software may be implemented by hardware, or a part of the functions realized by hardware may be implemented by software. In addition, it is possible to change the specific detailed configuration of the other each section of the smartphone 1 in any manner.

The step unit of the operation illustrated in FIG. 8 is produced by dividing the processing in accordance with the main processing contents to facilitate understanding of the operation of the print control section 102, and is not limited by the way of dividing the processing unit or by naming. The step unit may be divided into further more step units in accordance with the processing contents. Also, one step unit may include further more processing. Also, the order of the steps may be suitably replaced.

What is claimed is:

1. A non-transitory computer-readable storage medium storing a program to be executed by a computer, the program causing the computer to perform processing comprising:
receiving a print setting of document data including a plurality of pages;
displaying a first page image including a first image out of an image group including images corresponding to the pages of the document data; and
receiving a change instruction to change from display of the first page image to display of a second page image including a second image out of the image group, wherein
when the change instruction is received, changing from display of the first page image to display of the second page image in a change mode in accordance with the received the print setting.

2. The non-transitory computer-readable storage medium storing a program according to claim 1, wherein
the print setting is a setting to perform double-sided printing,
the first page image is a rectangle having a long side and a short side shorter than the long side, and
the change mode is a mode to rotate the first page image around a predetermined axis to change to display of the second page image.

3. The non-transitory computer-readable storage medium storing a program according to claim 2, wherein
when the print setting is a second setting different from the setting to perform the double-sided printing, the change mode is a mode different from a setting to perform the double-sided printing.

4. The non-transitory computer-readable storage medium storing a program according to claim 3, wherein
the second setting is a setting to perform single-sided printing, and
the change mode is a mode to slidingly move the first page image in a predetermined direction to delete and slidingly move the second page image to display.

5. The non-transitory computer-readable storage medium storing a program according to claim 2, wherein
the print setting is a setting to perform double-sided printing with long side binding, and
the change mode is a mode to rotate the first page image around the predetermined axis parallel to the long side of the first page image to change to display of the second page image.

6. The non-transitory computer-readable storage medium storing a program according to claim 2, wherein
the print setting is a setting to perform double-sided printing with short side binding, and
the change mode is a mode to rotate the first page image around the predetermined axis parallel to the short side of the first page image to change to display the second page image.

7. The non-transitory computer-readable storage medium storing a program according to claim 6, wherein
the change mode is a mode to slidingly move the first page image in a direction perpendicular to the short side and then rotate the first page image.

8. The non-transitory computer-readable storage medium storing a program according to claim 1, wherein
the print setting is a setting regarding a position of staple processing, and
the change mode is a mode to move the first page image based on the position.

9. The non-transitory computer-readable storage medium storing a program according to claim 1, further comprising:
when the received print setting includes a setting to perform layout printing, causing the computer to display by including a third image corresponding to layout printing in the first page image.

10. The non-transitory computer-readable storage medium storing a program according to claim 1, further comprising:
causing the computer to display the first page image in a first display area, and
display a plurality of thumbnail images included in a thumbnail image group corresponding to the image group in a second display area different from the first display area by arranging the plurality of thumbnail images in a predetermined direction.

11. The non-transitory computer-readable storage medium storing a program according to claim 10, wherein
when one of the thumbnail images is selected out of the plurality of thumbnail images displayed in the second display area, causing the computer to display the first page image in the first display area by using an image indicated by the one of the thumbnail images as the first image.

12. A display method of a print controller receiving a print setting of document data including a plurality of pages, the display method comprising:
displaying a first page image including a first image out of an image group including images corresponding to the pages of the document data; and
when receiving a change instruction to change from display of the first page image to display of a second page image including a second image out of the image group,
changing from display of the first page image to display of the second page image in a change mode in accordance with the received the print setting.

13. The display method according to claim 12, wherein
the print setting is a setting to perform double-sided printing,
the first page image is a rectangle having a long side and a short side shorter than the long side, and
the change mode is a mode to rotate the first page image around a predetermined axis to change to display of the second page image.

14. The display method according to claim 13, wherein
when the print setting is a second setting different from the setting to perform the double-sided printing, the change mode is a mode different from a setting to perform the double-sided printing.

15. The display method according to claim 14, wherein
the second setting is a setting to perform single-sided printing, and
the change mode is a mode to slidingly move the first page image in a predetermined direction to delete and slidingly move the second page image to display.

16. The display method according to claim 13, wherein
the print setting is a setting to perform double-sided printing with long side binding, and
the change mode is a mode to rotate the first page image around the predetermined axis parallel to the long side of the first page image to change to display of the second page image.

17. The display method according to claim 13, wherein
the print setting is a setting to perform double-sided printing with short side binding, and
the change mode is a mode to rotate the first page image around the predetermined axis parallel to the short side of the first page image to change to display the second page image.

18. The display method according to claim 17, wherein
the change mode is a mode to slidingly move the first page image in a direction perpendicular to the short side and then rotate the first page image.

19. The display method according to claim 12, wherein
the print setting is a setting regarding a position of staple processing, and
the change mode is a mode to move the first page image based on the position.

20. A print controller comprising:
a reception section configured to receive a print setting of document data including a plurality of pages and a change instruction to change from display of a first page image including a first image out of an image group including the pages of the document data to display of a second page image including a second image out of the image group;
a display section; and
a display controller configured to control display of the display section, wherein
when the reception section receives the change instruction, the display controller changes from display of the first page image to display of the second page image in a change mode in accordance with the print setting received by the reception section.
